(19) United States
(12) Patent Application Publication
(10) Pub. No.: US 2008/0047904 A1
(43) Pub. Date: Feb. 28, 2008

(54) Treatment for Hydrostatic Testing Water

(75) Inventor: Joel F. Carpenter, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 11/577,232

(22) PCT Filed: Oct. 18, 2004
(86) PCT No.: PCT/US04/34502

§ 371 Date: Apr. 13, 2007

(51) Int. Cl. C02F 1/50; C02F 5/08; C02F 9/04

(52) U.S. Cl. 210/747; 210/754; 252/179

(57) ABSTRACT

This invention provides a process for effecting biocidal activity in water used for hydrostatic testing. The process comprises blending a biocidally-effective amount of a sulfamate-containing bromine-based biocide with the water, and using at least a portion of the blended water for hydrostatic testing of at least a portion of an oil or gas pipeline. Also provided by this invention are compositions for use in hydrostatic testing. Such compositions comprise water blended with a biocidally-effective amount of a sulfamate-containing bromine-based biocide, where at least a portion of the composition is used for hydrostatic testing of at least a portion of an oil or gas pipeline.

### TECHNICAL FIELD

This invention relates to the treatment of water used in hydrostatic testing of oil and gas pipelines to prevent microbially induced corrosion.

### BACKGROUND

Hydrostatic testing of oil and gas pipelines is conducted to verify that they are leak-free and meet specified design criteria. Both new systems and older, established pipelines are subjected to hydrostatic testing. For this testing procedure, water is pumped into the pipeline to the rated pressure, and the water stays in the pipeline for a period of time during which the pressure in the pipeline is monitored. Once the hydrostatic test is complete, the test water is discharged into the environment, when regulations permit. The water used in the hydrostatic test can be harvested from a variety of readily available sources including surface seawater, surface freshwater, well waters and produced waters. The U.S. Environmental Protection Agency has promulgated regulations for chemically treated waters used in oil and gas activities.

The water used in the hydrostatic test must meet several criteria. The water must be non-corrosive to protect the integrity of the pipeline; non-scaling to prevent solids build-up in the pipeline, biostatic to prevent biofilm build up and microbially induced corrosion (MIC) of the pipeline, and the water must have a low toxicity for final discharge. In order to meet these criteria, the water is usually treated with one or more chemical substances to assist the water in meeting one or more of these criteria. Biocides have proven to be effective in controlling MIC. However, most biocides add toxicity to the treated water. The toxicity of the water is a problem because the water is normally discharged from the tested system into the surrounding environment after the completion of a hydrostatic test. Due to environmental regulations, the biocide(s) selected to treat water used in hydrostatic testing must not only inhibit MIC, but must also comply with these environmental requirements when discharged. Two biocides that have been used are glutaraldehyde and tetrakis(hydroxymethyl)phosphonium sulfate (THPS); see in this connection published U.S. Application No. 2003/0148527.

While biocide compositions are available that provide adequate biocidal activity in hydrostatic testing operations, further improvements in performance are desired. For example, a way of providing sufficiently long lasting residual biocidal activity using smaller amounts of biocidal agent would be of considerable advantage. Also, some biocides, particularly bleach, corrode metal pipe, which is normally used for pipelines. It would be advantageous if the biocide in addition to providing an effective amount of biocidal control, would cause, at most, minimal corrosion of metal pipes. It would be especially advantageous if the biocidal agent is compatible with other components used in hydrostatic testing operations, is relatively non-corrosive to metals, is effective against a variety of aerobic and anaerobic bacterial species, including sulfate-reducing species that produce hydrogen sulfide, and is capable of providing rapid microbiocidal activity promptly upon reaching the pipeline undergoing testing to reduce or prohibit microbiologically influenced corrosion.

### SUMMARY OF INVENTION

The present invention provides an effective method for treating hydrostatic testing water for inhibition of biofilm build-up and microbially induced corrosion (MIC). This invention provides sulfamate-containing bromine-based biocides as treatments for hydrostatic test waters for pipelines to minimize or prevent biofilm build-up and microbially induced corrosion (MIC). Advantageously, sulfamate-containing bromine-based biocides have minimal toxicity to higher organisms, which minimizes the environmental impact of water treated with sulfamate-containing bromine-based biocides upon final discharge of such water to the environment. A further advantage of water treated with a sulfamate-containing bromine-based biocide is that residuals of this biocide can be easily quenched upon the addition of a mild reducing agent.

Provided by this invention is a process for effecting biocidal activity in water for hydrostatic testing. This process comprises blending with the water a biocidally-effective amount of a sulfamate-containing bromine-based biocide, and using at least a portion of the blended water for hydrostatic testing of at least a portion of an oil or gas pipeline.

This invention also provides a method for hydrostatic testing of an oil or gas pipeline. The method comprises a) injecting water into said pipeline; b) closing both ends of said pipeline being tested; and c) monitoring the pressure in said pipeline. A bromine-based sulfamate-containing biocide is present in the water prior to the closing of both ends of the pipeline.

Also provided by this invention is a composition for use in hydrostatic testing. The composition is comprised of water blended with a biocidally-effective amount of a bromine-based sulfamate-containing biocide, wherein at least a portion of said composition is used for hydrostatic testing of at least a portion of an oil or gas pipeline.

These and other embodiments and features of this invention will be still further apparent from the ensuing description and appended claims.

### GLOSSARY

The following terms as used herein have the following meanings:
activity—This term describes the amount of oxidant available for microbiological control; the term is generally used to describe the amount of active material on a percentage (or ppm) basis in given formulation. Thus, for example, a solution that contains 15% of a particular biocidal species would be said to contain 15% active ingredient or 15% active, or 150,000 ppm active ingredient.
active bromine—This term denotes the amount of oxidant derived from a bromine-based biocide and available for microbiological control expressed relative to Br₂. Active bromine can be determined by several methods, for example, by the total bromine method described hereinafter.
biocidal activity—This term means discernable destruction of microbiological life.
biocidally-effective amount—This term denotes that the amount used controls, kills, or otherwise reduces the bacterial or microbial content of the aqueous fluid in question by a statistically significant amount as compared to the same aqueous fluid prior to treatment with a biocide of this invention.
bromine-based biocide—This term refers to a biocide in which the biocidal activity is provided by or theorized to be provided by bromonium ions.
bromonium ion—This term is used to describe bromine species in aqueous solution which have a formal positive charge and are capable of being microbiologically active. This is in contrast to bromide ion which has a formal negative charge and is not microbiologically active.
free bromine—This term is used to describe the free or relatively fast-reacting forms of oxidants derived from a bromine-based biocide present in aqueous solutions. It is typically determined by performing the DPD method for free chlorine residual and multiplying the result by the conversion factor of 2.25.
pipeline—The term “pipeline” refers to a pipeline or a portion of pipeline, of whatever length, that is to undergo hydrostatic testing. As is understood in the art, it is often more practical to test a section or portion of pipeline, rather than an entire length of pipeline.
ppm—This abbreviation means parts per million (wt/wt), unless specifically stated otherwise herein.
residual—The amount of oxidant in a fluid present at a given time after the oxidant has reacted with reactive impurities or components of the fluid.
total bromine—This term is used to describe both combined (stabilized or relatively non-reactive forms) and free (relatively fast-reacting) oxidants derived from a bromine-based biocide present in aqueous solutions. It is typically determined by performing the DPD method for total chlorine residual and multiplying the result by the conversion factor of 2.25. This test can be used to determine “activity” or “active bromine” as described above.
seawater—This term refers to any saline solution derived from the sea or other natural saline body of water, that is used in any water injection operation conducted in a system for the recovery of subterranean oil or gas whether conducted offshore or on land.

### FURTHER DETAILED DESCRIPTION OF THE INVENTION

Without wishing to be bound by theory, it is believed that in the sulfamate-containing bromine-based biocides used in the practice of this invention, bromonium ions in the water are in equilibrium with bromonium ions attached to the nitrogen atom of the sulfamate, and, as those bromonium ions in the water are consumed, bromonium ions attached to the sulfamate are released into the water. Thus, it is believed, again without wishing to be bound by theory, that the biocides used in this invention are in the form of monobromosulfamate, dibromosulfamate, and bromonium ions when in aqueous solution, and in the form of monobromosulfamate salts and dibromosulfamate salts when in solid form.

Preferred sulfamate-containing bromine-based biocides are those formed from (A) a bromine source which is (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine in proportions such that the total bromine to chlorine molar ratio is at least about 1, (B) a source of sulfamate anions, (C) alkali metal base, and (D) water, in amounts such that the sulfamate-containing bromine-based biocide has an active bromine content of at least 50,000 ppm, a pH of at least 7, and an atom ratio of nitrogen to active bromine originating from (A) and (B) that is greater than about 0.93. Preferably, the alkali metal base is a sodium or potassium base. More preferred biocides are those wherein the bromine source for the bromine-based sulfamate-containing biocide consists essentially of bromine chloride, wherein the alkali metal base is a sodium base, wherein the active bromine content of the biocide composition is at least 100,000 ppm, the atom ratio of nitrogen to active bromine originating from (A) and (B) is at least about 1, and the pH of the biocide composition is at least about 12. Particularly preferred biocides are those wherein the bromine source for the bromine-based sulfamate-containing biocide consists essentially of bromine chloride, wherein the alkali metal base is sodium hydroxide, wherein the active bromine content of the biocide composition is at least 140,000 ppm, the above atom ratio of nitrogen to active bromine originating from (A) and (B) is at least about 1.1, and the pH of the biocide is at least about 13.

More preferred aqueous biocides for use in this invention include highly concentrated aqueous bromine-based sulfamate-containing biocidal compositions which are solids-free aqueous solutions or solids-containing slurries formed as above, and in which the content of dissolved active bromine is greater than about 160,000 ppm. In preferred aqueous solutions of this type, the active bromine in these preferred liquid biocides is all in solution at room temperature (e.g., 23° C.). In one particularly preferred embodiment, the content of active bromine in such aqueous biocidal solutions is in the range of about 176,000 ppm to about 190,000 ppm (wt/wt). In another particularly preferred embodiment, the content of active bromine in such aqueous biocidal solutions is in the range of about 201,000 ppm to about 215,000 ppm.

Some highly concentrated sulfamate-containing bromine-based solutions and slurries also include aqueous biocide compositions comprising a water solution or slurry having in solution therein (I) an active bromine content derived from (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine, of greater than about 160,000 ppm (wt/wt), and (II) an overbased alkali metal salt of sulfamic acid (most preferably a sodium salt), and optionally containing—but preferably containing—(III) an alkali metal halide (preferably sodium chloride or sodium bromide, or both), wherein the relative proportions of (I) and (II) are such that the atom ratio of nitrogen to active bromine is greater than 0.93, and preferably is greater than 1 (e.g., in the range of above 1 to about 1.5) and wherein the pH of the composition is at least 7 (e.g., in the range of 10 to about 13.5, and preferably in the range of about 12.5 to about 13.5, or even as high as about 14). The content of active bromine in these solutions is typically in the range of above 160,000 ppm to about 215,000 ppm. Preferably, the content of active bromine in these concentrated liquid biocidal solutions is in the range of about 165,000 ppm (wt/wt) to about 215,000 ppm (wt/wt), more preferably in the range of about 170,000 ppm (wt/wt) to about 215,000 ppm (wt/wt), and still more preferably in the range of about 176,000 ppm (wt/wt) to about 215,000 ppm (wt/wt). More preferred are compositions as just described wherein the content of active bromine in the concentrated liquid biocidal compositions is in the range of about 176,000 ppm to about 190,000 ppm (wt/wt). Compositions as just described that are also more preferred are those wherein the content of active bromine in the liquid biocidal compositions is in the range of about 201,000 ppm to about 215,000 ppm.

Also preferred for use in this invention is a solid state sulfamate-containing bromine-based biocidal composition formed by removal of water from an aqueous solution or slurry of a product formed in water from (I) a bromine source which is (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine in proportions such that the total bromine to chlorine molar ratio is at least about 1; and (II) a source of overbased sulfamate which is (a) an alkali metal salt of sulfamic acid and/or sulfamic acid, and (b) an alkali metal base, wherein said aqueous solution or slurry has a pH of at least 7, preferably above 10 and more preferably above 12, and an atom ratio of nitrogen to active bromine from (I) and (II) of greater than 0.93. The concentration of the product formed in water from (I) and (II) used in forming the solid state sulfamate-containing bromine-based biocidal composition is not critical; any concentration can be present in the initial aqueous solution or slurry. Naturally it is desirable to start with a more concentrated solution or slurry as this lessens the amount of water that must be removed when preparing the solid state sulfamate-containing bromine-based biocidal composition.

Some of the highly concentrated aqueous solutions or slurries and the solid state bromine-based biocidal compositions described in the preceding paragraphs are novel compositions that are described in detail in commonly-owned copending application Ser. No. 10/282,290, filed Oct. 28, 2002, all disclosure of which is incorporated herein by reference.

The solid state sulfamate-containing bromine-based biocidal compositions of this invention are preferably formed by spray drying the aqueous solution or slurry of the product formed from (I) and (II) above. Temperatures of the atmosphere (e.g., dry air or nitrogen) into which the spray is directed is typically in the range of about 20 to about 100° C., and preferably is in the range of about 20 to about 60° C., particularly when the process is carried out at reduced pressure. When spray drying is used it is preferred to use the product formed from (1) and (II) as a solution rather than as a slurry as this minimizes the possibility of nozzle pluggage. On the other hand, if the water is to be flashed off or otherwise distilled from the solution or slurry of the product formed from (I) and (II), it is preferred to use the product formed from (I) and (II) as a slurry rather than as a solution as this minimizes the amount of water to be removed. Such flashing or distillations can be, and preferably are, conducted at reduced pressures to reduce the temperatures to which the product formed from (I) and (II) is exposed during drying.

The solid state bromine-based biocidal compositions of this invention are typically in the form of powders or relatively small particles. However the solid state bromine-based biocidal compositions of this invention can be compacted into larger forms such as nuggets, granules, pellets, tablets, pucks, and the like, by use of known procedures. Such compacted products may be formed with the use of binding agents or other materials that cause the particles to adhere one to another. If the binder used is not readily soluble in water, it is important not to totally encapsulate the product with a water-impervious coating of such binder that remains intact under actual use conditions, as this would prevent contact between the encapsulated bromine-based biocidal composition and the water being treated with the biocidal composition. Low melting waxes or the like may be used to bind and even to encapsulate the bromine-based biocidal composition in cases where the encapsulated product is used in waters at high enough temperatures to melt off the coating and bindings so that the water can come into contact with the previously encased biocidal composition itself. However, use of binding substances that are water-soluble or that provide effective binding action in proportions insufficient to encapsulate the particles being bound together, is preferable. The binding agent used should be compatible with the solid state bromine-based biocidal composition of this invention.

While biocides made by use of bromine can be used (e.g., U.S. Pat. No. 3,558,503) as the sulfamate-containing bromine-based biocides of this invention, preferred biocides of this invention because of their effectiveness and stability are formed from bromine chloride, bromine and chlorine, or a mixture of bromine chloride and up to about 50 mole % of bromine. A particularly preferred biocide of this type for use in the practice of this invention is commercially available from Albemarle Corporation under the trademark WELLGUARD® 7030 biocide. WELLGUARD® 7030 is normally made by adding bromine chloride to a solution or slurry of an alkali metal sulfamate. The sulfamate used in the production of such biocide products is effective in stabilizing the active bromine species over long periods of time, especially when the pH of the product is at least about 12 and preferably at least about 13. For example, WELLGUARD® 7030 biocide is stable for greater than one year if protected from sunlight. For ease of reference, these preferred highly effective and highly stable aqueous biocides for use in the practice of this invention formed from bromine chloride, bromine and chlorine, or a mixture of bromine chloride and up to about 50 mole % of bromine, a sulfamate source such as sulfamic acid or sodium sulfamate, a sodium base, typically NaOH, and water are often referred to hereinafter collectively as “preferred aqueous biocides” or “the preferred aqueous biocides”, and in the singular as “preferred aqueous biocide” or “the preferred aqueous biocide”.

Some of the biocides used in the practice of this invention are known. Methods for the preparation of the known biocides are given, for example, in U.S. Pat. Nos. 3,558,503; 6,068,861; 6,110,387; 6,299,909; 6,306,441; and 6,322,822. Another commercially-available biocide solution containing sulfamate which can be used in the practice of this invention is Stabrex™ biocide (Nalco Chemical Company). Stabrex™ is made by adding bleach to a sodium bromide solution in the presence of sulfamate.

Some components or impurities commonly encountered by the hydrostatic testing water are reactive with the biocides used pursuant to this invention. One such impurity is hydrogen sulfide. Another such impurity is oil, particularly hydrocarbonaceous oil. Such components are identifiable as substances which can be reactive in aqueous media with monobromo alkali metal sulfamate, dibromo alkali metal sulfamate, or bromonium ions. When such components are present, their presence can be overcome provided the quantity of such components can be effectively overcome by use of a sacrificial quantity of a biocide used pursuant to this invention. In some pipelines, residual amounts of corrosion inhibitor(s), scale inhibitor(s), and various other additives or components of well fluids used may be encountered. Many such common well fluid components are surprisingly compatible with biocides employed in the practice and compositions of this invention.

One of the advantages of using the preferred biocides is their great compatibility with other components used in hydrostatic test water. For example, unlike HOBr and hypobromites, the preferred biocides do not oxidize or otherwise destroy organic phosphonates typically used as corrosion and scale inhibitors. One water component that the biocides of this invention, including the preferred biocides, are not compatible with is hydrogen sulfide, which can react rapidly with these biocides. However, the amount of hydrogen sulfide encountered by the hydrostatic test water is expected to be minimal. Hydrogen sulfide may be found in either the source make-up water to formulate the hydrostatic test fluid, or it may be found as a residual in previously-used pipelines. When hydrogen sulfide is present, the amount is sufficiently small that it consumes only a small amount of the biocide, and the amount of the biocide present in water used in testing the pipeline should be sufficient not only to react with the hydrogen sulfide but additionally to provide a suitable residual quantity of active bromine in the pipeline. Since at least the preferred biocides are highly cost-effective, it is economically feasible to sacrifice some of the biocide as a means of destroying the hydrogen sulfide so that the remainder of the biocide in the hydrostatic testing water can provide the appropriate residual of active bromine in the pipeline being tested. Of course if the amount of hydrogen sulfide is so high as to make it non-feasible economically to destroy the hydrogen sulfide using the biocide, the use of the compositions of this invention in such pipeline is not recommended. The dividing line as between how much hydrogen sulfide can be tolerated and consumed with extra biocide pursuant to this invention and how much makes it non-feasible to do so will vary depending upon a number of variable economic factors as well as technical factors. For example, such factors as operating costs, pipeline location, particular biocide being used, degree of bacterial infestation, and the amount of active bromine residual needed or desired can have a significant effect upon how much hydrogen sulfide can be tolerated in any given situation. Therefore, the amount of hydrogen sulfide that can be tolerated and overcome in the hydrostatic test water pursuant to this invention is subject to considerable latitude and cannot be universally quantified. Suffice it to say that the pipeline being treated should either be free of hydrogen sulfide or may contain a “consumable amount” of hydrogen sulfide. As a general guide, it has been found that application of 50 ppm of WELLGUARD® 7030 biocide solution (thereby theoretically yielding 7.5 ppm residual as Br₂) provided about 2 ppm residual as Br₂ going into the pipeline, after exposure to typical surface freshwater halogen demand. In the presence of 5 ppm of hydrogen sulfide, it would take about 300 ppm of WELLGUARD® 7030 biocide solution (i.e., about 45 ppm residual as Br₂) to react with the hydrogen sulfide. To establish a suitable measurable residual, an additional amount in the range of about 10 to about 200 ppm, e.g., about 50 ppm of the WELLGUARD® 7030 biocide solution should be added. The presence of 5 ppm hydrogen sulfide thus increases the WELLGUARD® 7030 biocide solution application rate from about 50 ppm to about 350 ppm.

Besides providing very rapid biocidal activity upon coming in contact with the microorganisms in the hydrostatic testing water, the preferred biocides also provide sufficiently persistent and long lasting residual biocidal activity, e.g., provide a measurable residual lasting for a period of at least one hour and typically at least 2 hours in the water used in the hydrostatic test. Usually, extensive bacterial “knockdown” occurs within an hour or two.

The rapid bacterial “knockdown” (e.g., 1 or more log reduction of bacteria in one hour) activity achievable by the practice of this invention is surprising in view of the fact that the biocides are stabilized compositions by virtue of their sulfamate content. In short, despite their great stability, the preferred biocides function unexpectedly quickly.

Another advantage of the preferred biocides is that they are highly effective against a wide variety of heterotrophic bacteria, of both the aerobic and anaerobic types. Moreover, sulfate-reducing bacterial species are effectively controlled or killed by use of the preferred biocides. This in turn can eliminate, or at least greatly diminish, the generation of hydrogen sulfide which normally is produced as a product of bacterial reduction of sulfates.

Still another advantage of this invention is the very low corrosivity of the preferred biocides against metals, especially ferrous metals. This is the result of the low oxidation-reduction potential of the preferred biocides.

Yet another advantage of this invention is the stability of at least the preferred biocides at elevated temperatures. Thus unlike HOBr or hypobromite solutions which have relatively poor thermal stability at elevated temperatures, the preferred biocides can be used to test very deep pipelines where geothermally-produced highly elevated temperatures are encountered without premature decomposition. The preferred biocides can also be used in warm climate applications, e.g. in pipelines through deserts. This in turn provides the means for effectively combating heat resistant bacteria that reside at such locations.

The water used for the hydrostatic testing can be from any convenient source, including surface freshwater or seawater, well water, produced water, or a combination of any of the foregoing sources. Seawater is common choice, due its convenience in many operations.

In hydrostatic testing of oil and gas pipelines, water is injected into the pipeline, and the portion of pipeline to be tested is closed at both ends, pressurizing the water therein to the rated pressure. The pressure in the pipeline is monitored at a fixed point along the pipeline to determine if there are any leaks in the pipeline (leaks are indicated by a decrease in pressure). The biocide is present in the water in the pipeline before the pipeline is closed. The water remains in the pipeline for at least the duration of the hydrostatic test. However, the water can be, and often is, left in the pipeline after the test is completed, for a period of time which can range from a couple of days to several years.

The blending of water and the biocide can be conducted in any manner conventionally used in blending additives into water used in hydrostatic testing. Since many of the biocides, including the preferred biocides, whether formed on site or received from a manufacturer, are mobile aqueous solutions, the blending is rapid and facile. Simple metering or measuring devices and means for mixing or stirring the biocide with the water to be used in the hydrostatic test can thus be used, if desired. One way of operating is to pre-mix water and the biocide, and then inject the mixture into the pipeline to be tested. Another, preferred way of operating is to inject water and the biocide into the pipeline at about the same time, i.e., to cofeed the water and the biocide to the pipeline. When cofeeding water and the biocide to the pipeline, there is no requirement that the feeds be entirely co-extensive in time, and each feed may be interrupted at one or more points during the cofeed. A combination of premixing of the biocide and water and cofeeding of the biocide and water may also be used. Addition of the biocide after injection of the water into the pipeline is generally not considered to be practical, but if the portion of pipeline to be tested is short enough, post-injection of the biocide may be feasible.

The solid state sulfamate-containing bromine-based biocidal compositions referred to above are water soluble powders or particulate solids, and are easily blended with the water being used for hydrostatic testing. For example, the solids can be poured or metered into the water prior to injection of the water into the pipeline. Another suitable and preferred method is to cofeed the solid biocidal composition and water into the pipeline. A combination of these blending methods can be used.

Typically the amount of the biocide used should provide a residual in the range of about 1 to about 10 ppm, and preferably in the range of about 2 to about 6 ppm of active bromine species in the blended water for hydrostatic testing of the pipeline. Departures from these ranges whenever deemed necessary or desirable are permissible and are within the scope of this invention.

As is known in the art, it is often useful to include one or more other additives in the hydrostatic testing water, and the inclusion of such additives is contemplated in the practice of this invention. Any optional additives that are included in the water can be added to the water in any of the ways that the biocide can be added. The method for adding the optional additives, if any, may be the same or different than the method used for introducing the biocide to the water. Such additives normally include corrosion inhibitors and/or scale inhibitors. Typical corrosion inhibitors include filming amines. Suitable filming amines include N′,N′,N′-polyoxyethylene-(10)-N-tallow-1,3-diaminopropane, alkyldimethylbenzylammonium chloride, and the like; mixtures of two or more corrosion inhibitors can be used. Scale inhibitors are usually phosphates and/or phosphonates. Examples of phosphates and phosphonates that can be used include, but are not limited to, aminomethylene phosphonic acid, hydroxyethylidene diphosphonic acid, phosphonobutanetricarboxylic acid, and 2,2′,2″-nitrilotris(ethanol) phosphate. Mixtures of two or more scale inhibitors can be used.

Generally, after the hydrostatic test is complete, the hydrostatic test water can be discharged; typically, the water is discharged directly to into the environment, as regulations permit. While a certain amount of toxicity of the biocide is desirable (i.e., effective microbiocidal activity), toxicity to other organisms (e.g., macro-organisms), particularly those in the environment to which the water is discharged, is not desired, i.e., the water discharged from the pipeline should have a low toxicity to organisms in the environment. The preferred biocides of the invention are effective biocides for inhibiting microbially induced corrosion. In addition, the preferred biocides of the invention exhibit low toxicity toward organisms in the environment. Optionally, the preferred biocides of the invention can be quenched, further minimizing their environmental impact.

The residual biocide in the hydrostatic test water is normally quenched by a quenching agent, usually a mild reducing agent, such as an alkali metal sulfite or an alkali metal bisulfite. Suitable quenching agents include, but are not limited to, lithium sulfite, sodium sulfite, potassium sulfite, rubidium sulfite, cesium sulfite, ammonium sulfite, lithium sulfite, sodium bisulfite, potassium bisulfite, rubidium bisulfite, cesium bisulfite, ammonium bisulfite, lithium ascorbate, sodium ascorbate, potassium ascorbate, rubidium ascorbate, cesium ascorbate, ammonium ascorbate, lithium isoascorbate, sodium isoascorbate, potassium isoascorbate, rubidium isoascorbate, cesium isoascorbate, and ammonium isoascorbate. Preferred quenching agents are sodium salts and potassium salts, including sodium sulfite, potassium sulfite, sodium bisulfite, potassium bisulfite, sodium ascorbate, potassium ascorbate, sodium isoascorbate, and potassium isoascorbate. Especially preferred quenching agents are sodium salts, including sodium sulfite, sodium bisulfite, sodium ascorbate, and sodium isoascorbate. A mixture of any two or more quenching agents may be used.

When a quenching agent is used, it is usually blended with the hydrostatic test water in one of two ways. In one method, the hydrostatic test water is fed into a vessel, and the quenching agent is added to the water in the vessel. The water may be fed into the vessel in portions, as necessary or desired. Another method for blending quenching agent and hydrostatic test water, which is a preferred method, is to feed the quenching agent to the hydrostatic test water while the water is being discharged to the environment. The quenching agent(s) may be in solid form or in the form of an aqueous solution when blended with the hydrostatic test water.

The compositions of the invention can be formed by blending water and a sulfamate-containing bromine-based biocide, as described above, whether the blending occurs prior to injection (pre-mixing), or via a cofeed of the biocide and the water to the pipeline.

Standard analytical test procedures are available enabling close approximation of “total bromine” and “free bromine” present in the hydrostatic test water. For historical and customer familiarity reasons, these procedures actually express the results of the determinations as “free chlorine” and “total chlorine”, which results can then be arithmetically converted to “total bromine” and “free bromine”. The procedures are based on classical test procedures devised by Palin in 1974. See A. T. Palin, “Analytical Control of Water Disinfection With Special Reference to Differential DPD Methods For Chlorine, Chlorine Dioxide, Bromine, Iodine and Ozone”, J. Inst. Water Eng., 1974, 28, 139. While there are various modernized versions of the Palin procedures, the version of the tests for “free chlorine” and “total chlorine” recommended herein for use, are fully described in Hach Water Analysis Handbook, 3rd edition, copyright 1997. The procedure for “free chlorine” is identified in that publication as Method 8021 appearing on page 335, whereas the procedure for “total chlorine” is Method 8167 appearing at page 379. Briefly, the “free chlorine” test involves introducing to the halogenated water a powder comprising DPD indicator powder and a buffer. “Free chlorine” present in the water reacts with the DPD indicator to produce a red to pink coloration. The intensity of the coloration depends upon the concentration of “free chlorine” species present in the sample. This intensity is measured by a colorimeter calibrated to transform the intensity reading into a “free chlorine” value in terms of mg/L Cl₂. Similarly, the “total chlorine” test also involves use of DPD indicator and buffer. In this case, KI is present with the DPD and buffer whereby the halogen species present, including nitrogen-combined halogen, reacts with KI to yield iodine species which turn the DPD indicator to red/pink. The intensity of this coloration depends upon the sum of the “free chlorine” species and all other halogen species present in the sample. Consequently, this coloration is transformed by the calorimeter into a “total chlorine” value expressed as mg/L Cl₂.

In greater detail, these procedures are as follows:
1. To determine the amount of species present in the hydrostatic test water which respond to the “free chlorine” and “total chlorine” tests, the sample should be analyzed within a few minutes of being taken, and preferably immediately upon being taken.
2. Hach Method 8021 for testing the amount of species present in the sample which respond to the “free chlorine” test involves use of the Hach Model DR 2010 calorimeter or equivalent. The stored program number for chlorine determinations is recalled by keying in “80” on the keyboard, followed by setting the absorbance wavelength to 530 nm by rotating the dial on the side of the instrument. Two identical sample cells are filled to the 10 mL mark with the aqueous sample under investigation. One of the cells is arbitrarily chosen to be the blank. Using the 10 mL cell riser, this is admitted to the sample compartment of the Hach Model DR 2010, and the shield is closed to prevent stray light effects. Then the ZERO key is depressed. After a few seconds, the display registers 0.00 mg/L Cl₂. To a second cell, the contents of a DPD Free Chlorine Powder Pillow are added. This is shaken for 10-20 seconds to mix, as the development of a pink-red color indicates the presence of species in the sample which respond positively to the DPD test reagent. Within one minute of adding the DPD “free chlorine” reagent to the 10 mL of aqueous sample in the sample cell, the blank cell used to zero the instrument is removed from the cell compartment of the Hach Model DR 2010 and replaced with the test sample to which the DPD “free chlorine” test reagent was added. The light shield is then closed as was done for the blank, and the READ key is depressed. The result, in mg/L Cl₂ is shown on the display within a few seconds. This is the “free chlorine” level of the water sample under investigation.
3. Hach Method 8167 for testing the amount of species present in the aqueous sample which respond to the “total chlorine” test involves use of the Hach Model DR 2010 calorimeter or equivalent. The stored program number for chlorine determinations is recalled by keying in “80” on the keyboard, followed by setting the absorbance wavelength to 530 nm by rotating the dial on the side of the instrument. Two identical sample cells are filled to the 10 mL mark with the water under investigation. One of the cells is arbitrarily chosen to be the blank. To the second cell, the contents of a DPD Total Chlorine Powder Pillow are added. This is shaken for 10-20 seconds to mix, as the development of a pink-red color indicates the presence of species in the water which respond positively to the DPD “total chlorine” test reagent. On the keypad, the SHIFT TIER keys are depressed to commence a three-minute reaction time. After three minutes the instrument beeps to signal the reaction is complete. Using the 10 mL cell riser, the blank sample cell is admitted to the sample compartment of the Hach Model DR 2010, and the shield is closed to prevent stray light effects. Then the “ZERO” key is depressed. After a few seconds, the display registers 0.00 mg/L Cl₂. Then, the blank sample cell used to zero the instrument is removed from the cell compartment of the Hach Model DR 2010 and replaced with the test sample to which the DPD “total chlorine” test reagent was added. The light shield is then closed as was done for the blank, and the READ key is depressed. The result, in mg/L Cl₂ is shown on the display within a few seconds. This is the “total chlorine” level of the water sample under investigation.
4. To convert the readings to bromine readings, the “free chlorine” and the “total chlorine” values should be multiplied by 2.25 to provide the “free bromine” and the “total bromine” values.

The following examples are presented for purposes of illustration, and are not intended to impose limitations on the scope of this invention.

### EXAMPLE 1

Samples from two random lots of WELLGUARD® 7030 biocide (Albemarle Corporation) were subjected to tests conducted substantially in accordance with the Official Methods of Analysis of AOAC International 17th Edition, 2000 Chapter 6, Disinfectants Section 965.13. Each lot of test substance was tested in triplicate at 10 ppm, measured as bromine, in Instant Ocean salt solution prepared with “chlorine demand free” water against the respective test organisms, Desulfovibrio desulfuricans subsp. desulfuricans, ATCC 7757, Bacillus cereus, ATCC 11778, and Pseudomonas fluorescens, ATCC 13525. Instant Ocean synthetic sea salt is available from Aquarium Systems, Inc., Mentor, Ohio. A dilution/aliquot of the test material was brought into contact with a known population of test bacteria for a specified period of time. A sample was then plated to enumerate the surviving bacteria. The log₁₀ survivors and log₁₀ reduction from the original population were calculated. The exposure conditions were 10 minutes, 1 hour, 3 hours and 24 hours for Desulfovibrio desulfuricans and 10 minutes, 1 hour, and 3 hours for Bacillus cereus and Pseudomonas fluorescens at 20±1° C. The average log₁₀ survivors and the average log₁₀ reduction in numbers of bacteria, compared to an untreated control, were calculated for each time point for both lots of WELLGUARD® 7030 biocide. The test results are summarized in Table 1.

It can be seen that at 10 ppm bromine and with a 10 minute exposure time, a >3 log₁₀ reduction in numbers of test bacteria was shown with both lots of WELLGUARD® 7030 biocide against Desulfovibrio desulfuricans subsp. desulfuricans, ATCC 7757. Under the same test conditions, with up to 3 hours of exposure, no reduction in numbers of Pseudomonas fluorescens, ATCC 13525 was seen and ˜0.3 log₁₀ reduction in numbers of Bacillus cereus, ATCC 11778 was seen for both lots of WELLGUARD® 7030Biocide.

TABLE 1
SUMMARY TABLE OF RESULTS-LOG₁₀ REDUCTION
Summary of Results for WELLGUARD ® 7030 @ 10 ppm bromine
Diluted in ½ cup/gal “Instant Ocean”

| | | B. cereus, | | D. desulfuricans subsp. | | P. fluorescens, | |
|---|---|---|---|---|---|---|---|
| | | ATCC 11778 | | desulfluricans, ATCC 7757 | | ATCC 13525 | |
| Sample Id./ | | *Log₁₀ | **Log₁₀ | Log₁₀ | Log₁₀ | Log₁₀ | Log₁₀ |
| Exposure | | Survivors/mL | Reduction | Survivors/mL | Reduction | Survivors/mL | Reduction |
| 8525-66-1 | 10 | 6.04 | 0.11 | <2.00 | >3.00 | 4.91 | NR |
| MDV-99-2 | MIN. | 6.08 | 0.07 | <2.00 | >3.00 | 4.84 | NR |
| 8525-66-1 | 1 | 5.91 | 0.24 | <2.00 | >3.00 | 4.84 | NR |
| MDV-99-2 | hour | 6.00 | 0.15 | <2.00 | >3.00 | 4.91 | NR |
| 8525-66-1 | 3 | 5.88 | 0.27 | <2.00 | >3.00 | 4.84 | NR |
| MDV-99-2 | hour | 5.82 | 0.33 | <2.00 | >3.00 | 4.77 | NR |
| 8525-66-1 | 24 | NT | NT | <2.00 | >3.00 | NT | NT |
| MDV-99-2 | hour | NT | NT | <2.00 | >3.00 | NT | NT |

| | Log₁₀/mL | CFU/mL | Log₁₀/mL | CFU/mL | Log₁₀/mL | CFU/mL |
|---|---|---|---|---|---|---|
| Untreated | 6.15 | 1.4 × 10⁶ | ˜5.00 | ˜1.0 × 10⁵ | 4.73 | 5.4 × 10⁴ |
| Numbers Control | | | | | | |
| CFU/mL | | | | | | |

NR = No Reduction
NT = Not Tested
*Log₁₀ of CFU/mL (average of three replicate tests)
**Reduction as compared to untreated numbers control

### EXAMPLE 2

Corrosivity was studied using Linear Polarization Resistance (LPR). Synthetic seawater was prepared by dissolving synthetic sea salt (“Instant Ocean”, Aquarium Systems) in deionized water to form a 3 wt % total dissolved solids (TDS) solution. The aerated solutions were prepared by bubbling air into the synthetic seawater at 100 mL/min for at least 1 hour. The deaerated solutions were prepared by bubbling nitrogen into the synthetic seawater at 100 mL/min for at least 1 hour. The test solutions were prepared by adding WELLGUARD® 7030 or glutaraldehyde to 950 g of the above synthetic seawater after aeration or deaeration. For the 100-ppm BrCl test solutions, 0.87 g WELLGUARD® 7030 (11 wt % BrCl) was added to the synthetic seawater. For the 10-ppm BrCl test solutions, 9.6 g of a stock solution of 1000 ppm of BrCl in deionized water was added to the synthetic seawater. The 1200-ppm glutaraldehyde test solutions were prepared by adding 2.30 g 50% glutaraldehyde to the synthetic seawater. The 600-ppm glutaraldehyde test solutions were prepared by adding 1.15 g of 50% aqueous glutaraldehyde was added to the synthetic seawater. For each test, 950 g of the test solution was placed into a 1000 mL glass cell. A graphite rod was used as counterelectrode. A saturated calomel electrode (SCE) was used as a reference electrode. A carbon steel (C1018) cylinder (0.95 cm diameter, 1.25 cm height) was used as a working electrode. The working electrode was degreased with acetone before insertion into the test solution. The electrodes were set into the solution for one hour to establish an open circuit potential (Eoc). After measuring the Eoc, a potential voltage from −10 mV to +10 mV around the Eoc was applied at 0.167 mV/second. The current-potential was monitored by a DC corrosion technique computer program (DC-105, Gamry Instruments, Warminster, Pa.). The apparatus was pre-calibrated according to ASTM G-5-94 “Standard Reference Test Method for Making Potentiostatic and Potentiodynamic Anodic Polarization Measurements”.

Results are summarized in Table 2; the units in the Table are mils per year (mpy). Each entry in the Table is an average of five measurements. At the recommended treatment rates of 10 ppm BrCl (for WELtGUARD® 7030) and 600 ppm glutaraldehyde, the corrosion profiles appeared to be similar to the synthetic seawater diluent.

TABLE 2

| | Temperature | | | |
|---|---|---|---|---|
| | Room temp. | Room temp. | 60° C. | 60° C. |
| Aeration | Aerated | Deaerated | Aerated | Deaerated |
| Blank | 4.8 | 0.3 | 11.7 | 4.7 |
| BrCl, 10 ppm | 6.1 | 1.0 | 6.3 | 9.7 |
| BrCl, 100 ppm | 7.1 | 3.5 | 12.3 | 11.9 |
| Glutaraldehyde, 600 | 6.4 | 0.6 | 5.3 | 4.8 |
| ppm | | | | |
| Glutaraldehyde, 1200 | 9.2 | 1.4 | 8.8 | 5.5 |
| ppm | | | | |

### EXAMPLE 3

Deionized water (1000 g) was blended with 35.8 g of Instant Ocean. Half of this blend was removed, and its pH was adjusted to 6.5 with aqueous HCl (1.0 M); this was solution A, which was stored in a brown glass bottle. The other half of the blend had its pH adjusted to 8.0 with aqueous NaHCO₃ (1.0 M); this was solution B, which was also stored in a brown glass bottle. Using at 1 mL syringe, about 0.3500 g WELLGUARD® 7030 was weighed into both solution A and solution B. After about 0.5 hour, the Br₂ content of each solution was measured using a DPD meter (Hach Company). A portion of solution A (100 g) was transferred to another brown bottle. Sodium hydrogen sulfite (0.0250 g) was added to this portion of solution A. The residual Br₂ was measured using the DPD meter after 5 minutes, 15 minutes, 1 hour, and 4 hours. A portion of solution B (100 g) was also removed, similarly treated with sodium hydrogen sulfite, and monitored for Br₂. Carbon steel coupons (ANSI C1018, Metal Sample Co.) having dimensions 3 inches×½ inch×⅛ inch (7.6 cm×1.3 cm×0.32 cm) were used as the test metal. The metal coupons were rinsed with acetone and dried. A portion of solution A (100 g) was placed in a wide-mouth brown bottle with metal coupon. The residual Br₂ was measured using the DPD meter at 5 minutes, 15 minutes, 1 hour, and 4 hours. The test with a metal coupon was repeated with a portion of solution B (100 g). Results of all of these runs are summarized in Table 3; values reported therein are in ppm of total Br₂.

At both pH 6.5 and 8.0 in a seawater matrix, the residual Br₂ was stable over a 1 day period. At both pH 6.5 and 8.0 in a seawater matrix, sodium bisulfite instantaneously (<5 min) scavenged the total bromine content. At both pH 6.5 and 8.0 in a seawater matrix, exposed to C1018 carbon steel, 75-67% of the total bromine content remained after 4 hours, and 2-4% of the total bromine content remained after 1 day.

TABLE 3

| | | | Seawater + | | Seawater + | |
|---|---|---|---|---|---|---|
| Time | Seawater | | NaHSO₃ | | carbon steel | |
| elapsed | pH 6.5 | pH 8.0 | pH 6.5 | pH 8.0 | pH 6.5 | pH 8.0 |
| 0 minutes | — | — | 135 | 108 | 135 | 107 |
| 5 minutes | — | — | 0 | 0 | 134 | 109 |
| 15 minutes | — | — | 0 | 0 | 127 | 101 |
| 30 minutes | 135 | 107 | | | | |
| 1 hour | — | — | 0 | 0 | 119 | 93 |
| 4 hours | — | — | 0 | 0 | 90 | 82 |
| 6 hours | 136 | 136 | — | — | — | — |
| 24 hours | 133 | 107 | — | — | 2.2 | 4.4 |

### EXAMPLE 4

WELLGUARD® 7030 and bleach were tested against Medinia beryllina larvae and Mysidopsis bahia juveniles in 48-hour acute LC₅₀ assays with static renewal of the medium at each 24 hour interval. The test concentrations were prepared daily, and used immediately for test initiation and renewal. The total residual chlorine was measured in the highest concentration tested for each sample. The measured chlorine concentrations were used to calculate the estimated chlorine concentrations at the lower sample dilutions in these tests. Both range finder and definitive assays were conducted. Results are summarized in Table 4.

A second set of experiments were conducted to mimic aged treated seawater. This attempted to model water that had been held in a pipeline for 24 hours, and then discharged. The experiments were identical to those described in the preceding paragraph, except that the highest test concentrations were prepared 24 hours before exposure to the test organisms. These same solutions were then used to prepare the 24 hour static renewal concentrations. The residual chlorine concentrations were measured when the test organisms were initially exposed to the toxic insult. These measurement were used to calculate the estimated chlorine concentrations at the lower sample dilutions in these tests, and after the static renewal at 24 hours. Results are summarized in Table 4.

The marine ecotoxicity profiles of WELLGUARD® 7030 were comparable to bleach in the 48-hour static assays against Mysidopsis bahia and Medinia beryllina, as shown in Table 4. In the field, however, hydrostatic test waters will experience considerable demand from factors such as other additives present, the material of construction (MOC) of the system, residual hydrocarbons in the pipeline, and the quality of the source water. Under such conditions, the biocides may behave differently.

TABLE 4

| | Mysidopsis bahia | | Medinia beryllina | |
|---|---|---|---|---|
| | WELLGUARD ® 7030 | bleach | WELLGUARD ® 7030 | bleach |
| fresh | 0.87 ppm as Cl₂ | 0.34 ppm as Cl₂ | 0.40 ppm as Cl₂ | 0.57 ppm as Cl₂ |
| aged | 1.07 ppm as Cl₂ | 0.42 ppm as Cl₂ | 0.46 ppm as Cl₂ | 0.50 ppm as Cl₂ |

### EXAMPLE 5

Additional toxicity data on sulfamate-containing bromine-based biocides against fresh water organisms was generated using the ASTM E729-96 test, which is for testing the acute toxicity of materials to fishes, macroinvertebrates, and amphibians. The tests were begun when the organisms were placed in the solutions containing the material to be tested. Here, the material that underwent testing was WELLGUARD® 7030. Three aquatic species were tested. For the bluegill sunfish (Lepomis macrochirus), test animals ranged from 1.3 to 2.0 cm in standard length and from 0.080 to 1.33 mg fresh weight as measured on the control animals at test termination. The instantaneous loading of bluegill was 0.07 g/L. Seven concentrations of WELLGUARD® 7030 (1.3, 2.5, 5.0, 10, 20, 40, and 80 mg wm/L) were tested. A minimum of 10 bluegill were tested per concentration. The exposure period lasted for 96 hours, and observations of mortality were made at 24-hour intervals. The estimated 96-hour lethal concentration value (LC₅₀) for the bluegill sunfish was 3.8 mg whole material per liter (wm/L). Waterflea (Daphnia magna) were tested at five concentrations of WELLGUARD® 7030 biocide (0.38, 0.75, 1.5, 3.0 and 6.0 mg wm/L). Each treatment level and control was replicated twice. Ten Daphnia magna neonates were used per treatment. The exposure period lasted for 48 hours, and observations of immobility/mortality were made at 24 and 48 hours. The estimated 48-hour effective concentration value (EC₅₀) was 4.8 mg wm/L. For the unicellular green alga (Selenastrum capricornutum), the initial inoculation density was approximately 1×10⁴ cells/mL. Cell counts were made at 24, 48, 72 and 96 hours after inoculation. Five concentrations of the sample (0.25, 0.50, 1.0, 2.0, and 4.0 mg wm/L) were tested. Each treatment level and control was replicated three times. The estimated 96-hour inhibitory concentration value (IC₅₀) based on cell density was 2.6 mg wm/L.

### EXAMPLE 6

### Comparative Study of Compatibilities of Several Halogen-Based Biocides Toward Phosphonate Additives

The biocides studied consisted of WELLGUARD® 7030, bleach (NaOCl), and activated sodium bromide (NaOCl and NaBr). The WELLGUARD® 7030 and bleach were added directly. Activated sodium bromide was prepared in situ by introducing 20 ppm bromide ion to the stock solution followed by addition of bleach. The phosphonates used in this work consisted of AMP (aminomethylene phosphonic acid), HEDP (hydroxyethylidene diphosphonic acid), and PBTC (phosphonobutanetricarboxylic acid). These materials were commercial samples (Mayoquest 1320, 1500, and 2100, respectively) obtained from Callaway Chemical Co. (Smyrna, Ga.).

Solutions consisting of 5 ppm scale inhibitor (as active phosphonate) in the presence of 10 ppm oxidant (as Cl₂) were prepared as follows. To 900 mL deionized water were added appropriate stock solutions containing phosphonate, alkalinity (NaHCO₃), and calcium hardness (CaCl₂). The pH was adjusted to 9.1 with 5% aq. NaOH and diluted up to 1 L in a dark amber bottle. A dose of oxidant was added to achieve a residual of 10 ppm. The solutions were then periodically monitored for phosphonate reversion by determining the reversion to orthophosphate (Hach method 490). The oxidant residual was also periodically monitored using the DPD method (Hach method 80). All of this work was performed at room temperature (23° C.). The initial active phosphonate content was confirmed by conversion to orthophosphate via UV/persulfate oxidation followed by a conventional phosphate analysis (Hach method 501). A conversion factor was applied to the phosphate measurement to determine the initial amount of active phosphonate present as follows: AMP, 1.05; HEDP, 1.085; PBTC, 2.85.

The experimental data for the effect of the various biocides on AMP, HEDP, and PBTC are presented in Tables 5, 6, and 7, respectively.

TABLE 5
Effect of Oxidizing Biocides on Reversion of AMP to Orthophosphate

| Time, | | WELLGUARD ® | Activated | |
|---|---|---|---|---|
| minutes | Analysis, ppm | 7030 | NaBr | Bleach |
| 0 | Phosphate | 4.58¹ | 4.18¹ | 4.22¹ |
| 0 | Active | 4.8 | 4.4 | 4.4 |
| | Phosphonate² | | | |
| 20 | Phosphate | 0.36 | 0.82 | 0.35 |
| 40 | Phosphate | 0.22 | 0.99 | 0.7 |
| 70 | Phosphate | 0.16 | 1.1 | 0.53 |
| 100 | Phosphate | 0.36 | 1.27 | 0.75 |
| 130 | Phosphate | 0.24 | 1.36 | 0.8 |
| 190 | Phosphate | — | 1.15 | 0.77 |
| 220 | Phosphate | 0.36 | 1.07 | 0.59 |
| 250 | Phosphate | 0.33 | 1.2 | 0.64 |
| 280 | Phosphate | 0.32 | 1.08 | 0.83 |
| 310 | Phosphate | 0.32 | 1.12 | 0.82 |
| 340 | Phosphate | 0.32 | 1.15 | 0.8 |
| 370 | Phosphate | 0.32 | 1.13 | 0.81 |
| 400 | Phosphate | 0.35 | 1.22 | 0.79 |
| 460 | Cl₂ | 10.2 | 8.6 | 9.4 |
| 520 | Phosphate | 0.3 | 1.31 | 0.97 |
| 1360 | Phosphate | 0.47 | 0.88 | 0.91 |
| 100-1360 | Phosphate | 0.34 | 1.16 | 0.79 |
| | (average) | | | |

¹Maximum amount of ortho-phosphate that can be liberated (determined by UV/persulfate oxidation of AMP, Hach method 501).
²Phosphate analysis X conversion factor (= 1.05).

TABLE 6
Effect of Oxidizing Biocides on Reversion of HEDP to Orthophosphate

| Time, | | WELLGUARD ® | Activated | |
|---|---|---|---|---|
| minutes | Analysis, ppm | 7030 | NaBr | Bleach |
| 0 | Phosphate | 4.20¹ | 4.40¹ | 4.80¹ |
| 0 | active | 4.6 | 4.8 | 5.2 |
| | phosphonate² | | | |
| 20 | Phosphate | 0.24 | 0.67 | 0 |
| 40 | Phosphate | 0.01 | 1.69 | 0 |
| 70 | Phosphate | 0.05 | 1.93 | 0.2 |
| 100 | Phosphate | 0.08 | 1.96 | 0.25 |
| 130 | Phosphate | 0.12 | 2.11 | 0.31 |
| 190 | Phosphate | 0.21 | 2.58 | 0.61 |
| 220 | Phosphate | 0.24 | 2.55 | 0.65 |
| 250 | Phosphate | 0.18 | 2.63 | 0.39 |
| 280 | Phosphate | 0.2 | 2.66 | 0.41 |
| 310 | Phosphate | 0.3 | 2.71 | 0.58 |
| 340 | Phosphate | 0.39 | 2.75 | 0.65 |
| 370 | Phosphate | 0.35 | 2.25 | 0.84 |
| 400 | Phosphate | 0.33 | 2.34 | 0.65 |
| 400 | Cl₂ | 10.5 | 6.85 | 10.6 |
| 460 | Phosphate | 0.37 | 2.37 | 0.95 |
| 520 | Phosphate | 0.5 | 2.75 | 0.94 |

¹Maximum amount of ortho-phosphate that can be liberated (determined by UV/persulfate oxidation of AMP, Hach method 501).
²Phosphate analysis X conversion factor (= 1.085).

TABLE 7
Effect of Oxidizing Biocides on Reversion of PBTC to Orthophosphate

| Time, | | WELLGUARD ® | Activated | |
|---|---|---|---|---|
| minutes | Analysis, ppm | 7030 | NaBr | Bleach |
| 0 | Phosphate | 1.72¹ | 1.82¹ | 1.44¹ |
| 0 | active | 4.9 | 5.2 | 4.1 |
| | phosphonate² | | | |
| 30 | Phosphate | 0 | 0 | 0 |
| 60 | Phosphate | 0 | 0 | 0 |
| 90 | Phosphate | 0 | 0 | 0 |
| 120 | Phosphate | 0 | 0 | 0 |
| 150 | Phosphate | 0 | 0 | 0 |
| 180 | Phosphate | 0 | 0 | 0 |
| 210 | Phosphate | 0 | 0.38 | 0.12 |
| 270 | Phosphate | 0.2 | 0.24 | 0.16 |
| 330 | Phosphate | 0.08 | 0.04 | 0.05 |
| 360 | Phosphate | 0.06 | 0.17 | 0.02 |
| 390 | Phosphate | 0.09 | 0.01 | 0.02 |
| 390 | Phosphate | 8.75 | 9.6 | 9.5 |
| 1360 | Phosphate | 0.06 | 0.02 | 0.08 |
| 210-1360 | Phosphate, | 0.082 | 0.142 | 0.075 |
| | average | | | |

¹Maximum amount of ortho-phosphate that can be liberated (determined by UV/persulfate oxidation of AMP, Hach method 501).
²Phosphate analysis X conversion factor (= 2.85).

The data in Table 5 show that WELLGUARD® 7030, a preferred biocide, is less aggressive towards AMP than either bleach and activated sodium bromide toward amino methylene phosphonic acid (AMP), a common phosphonate additive. The relative order is:

WELLGUARD® 7030<bleach<activated sodium bromide Although there is some scatter in the data, phosphonate reversion remained essentially unchanged with all biocides within 100 minutes of reaction time. The averaged amounts of phosphonate reversion were 7.4% (WELLGUARD® 7030), 18.7% (bleach), and 27.8% (activated sodium bromide).

The data in Table 6 show that WELLGUARD® 7030 biocide is also less aggressive toward hydroxyethylidene diphosphonic acid (HEDP), another common phosphonate additive than the other two biocides tested. In fact, HEDP is significantly less stable in the presence of activated sodium bromide than both bleach or WELLGUARD® 7030. Phosphonate reversion appeared to increase regularly with time with all biocides although again there is some scatter in the data. The relative amounts of reversion after 520 minutes were 11.9% (WELLGUARD® 7030), 19.6% (bleach), and 62.5% (activated sodium bromide).

From the data in Table 7 it can be seen that none of the biocides was particularly aggressive towards phosphonobutanetricarboxylic acid (PBTC). In fact no phosphonate reversion was detected with any biocide until 3½ hours of contact. The average amounts of phosphonate reversion after 3½ hours contact and beyond were 4.8% (WELLGUARD® 7030), 5.2% (bleach), and 7.8% (activated sodium bromide).

It is evident from the results summarized in Tables 5, 6, and 7 that WELLGUARD® 7030 used pursuant to this invention is significantly less aggressive to commonly used phosphonates in comparison to bleach and activated sodium bromide. This in turn indicates that at least the preferred biocides used pursuant to this invention offer increased compatibility with potential well fluid component additives as compared to bleach and activated sodium bromide.

It is to be understood that the reactants and components referred to by chemical name or formula anywhere in this document, whether referred to in the singular or plural, are identified as they exist prior to coming into contact with another substance referred to by chemical name or chemical type (e.g., another reactant, a solvent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical operation or reaction or in forming a mixture to be used in conducting a desired operation or reaction. Also, even though an embodiment may refer to substances, components and/or ingredients in the present tense (“is comprised of”, “comprises”, “is”, etc.), the reference is to the substance, component or ingredient as it existed at the time just before it was first contacted, blended or mixed with one or more other substances, components and/or ingredients in accordance with the present disclosure.

Also, even though the claims may refer to substances in the present tense (e.g., “comprises”, “is”, etc.), the reference is to the substance as it exists at the time just before it is first contacted, blended or mixed with one or more other substances in accordance with the present disclosure.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

1. A process for effecting biocidal activity in water for hydrostatic testing, which process comprises blending with said water a biocidally-effective amount of a sulfamate-containing bromine-based biocide, and using at least a portion of the blended water for hydrostatic testing of at least a portion of an oil or gas pipeline.

2. A process as in claim 1 wherein the biocide used in said blending is an aqueous concentrate formed from (A) a bromine source which is (i) bromine, (ii) bromine chloride, (iii) a mixture of bromine chloride and bromine, (iv) bromine and chlorine in a bromine to chlorine molar ratio of at least about 1, (v) bromine chloride, bromine, and chlorine in proportions such that the total bromine to chlorine molar ratio is at least about 1, (B) a source of sulfamate anions, (C) alkali metal base, and (D) water, in amounts such that the biocide has an active bromine content of at least 50,000 ppm, a pH of at least 7, and an atom ratio of nitrogen to active bromine from (A) and (B) that is greater than about 0.93.

3. A process as in claim 2 wherein said active bromine content is at least 100,000 ppm.

4. A process as in claim 2 wherein said active bromine content is above 160,000 ppm.

5. A process as in claim 2 wherein said active bromine content is in the range of about 176,000 ppm to about 190,000 ppm.

6. A process as in claim 2 wherein said active bromine content is in the range of about 201,000 ppm to about 215,000 ppm.

7. A process as in claim 1 wherein the biocide used in said blending is an aqueous concentrate that has a pH of at least about 12.

8. A process as in claim 2 wherein said aqueous concentrate has a pH of at least about 12.

9. A process as in claim 1 wherein the biocide used in said blending is a solid state sulfamate-containing bromine-based biocidal composition formed by removal of water from an aqueous solution or slurry of a sulfamate-containing bromine-based biocide.

10. A process as in claim 9 wherein the aqueous solution or slurry from which water is removed is a product formed in water from (I) a bromine source which is (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine in proportions such that the total bromine to chlorine molar ratio is at least about 1; and (II) a source of overbased sulfamate which is (a) an alkali metal salt of sulfamic acid and/or sulfamic acid, and (b) an alkali metal base, wherein said aqueous solution or slurry has a pH of at least 7, and an atom ratio of nitrogen to active bromine from (I) and (II) of greater than 0.93.

11. A process as in claim 10 wherein the pH of said aqueous solution or slurry before removal of the water therefrom is above 7, and wherein the atom ratio of nitrogen to active bromine from (I) and (II) of said aqueous solution or slurry before removal of the water therefrom is greater than 1.

12. A process as in claim 1 wherein said blending is carried out by cofeeding water and the biocide to the pipeline.

13. A method for hydrostatic testing of at least a portion of an oil or gas pipeline, which method comprises
a) injecting water into said pipeline;
b) closing both ends of said pipeline being tested; and
c) monitoring the pressure in said pipeline,
wherein a sulfamate-containing bromine-based biocide is present in the water prior to said closing of both ends of said pipeline.

14. A method as in claim 13 further comprising discharging said water to the environment.

15. A method as in claim 14 further comprising quenching said biocide.

16. A method as in claim 15 wherein said quenching is carried out by feeding a quenching agent to the water during said discharging.

17. A method as in claim 15 wherein said quenching is carried out by the use of a quenching agent selected from the group consisting of sodium sulfite, potassium sulfite, sodium bisulfite, potassium bisulfite, sodium ascorbate, potassium ascorbate, sodium isoascorbate, potassium isoascorbate, and mixtures of any two or more of these.

18. A method as in claim 15 wherein said quenching agent is selected from the group consisting of sodium sulfite, sodium bisulfite, sodium ascorbate, sodium isoascorbate, and mixtures of any two or more of these.

19. A method as in claim 13 wherein the biocide present in said water is an aqueous concentrate formed from (A) a bromine source which is (i) bromine, (ii) bromine chloride, (iii) a mixture of bromine chloride and bromine, (iv) bromine and chlorine in a bromine to chlorine molar ratio of at least about 1, (v) bromine chloride, bromine, and chlorine in proportions such that the total bromine to chlorine molar ratio is at least about 1, (B) a source of sulfamate anions, (C) alkali metal base, and (D) water, in amounts such that the biocide has an active bromine content of at least 50,000 ppm, a pH of at least 7, and an atom ratio of nitrogen to active bromine from (A) and (B) that is greater than about 0.93.

20. A method as in claim 19 wherein said active bromine content is at least 100,000 ppm.

21. A method as in claim 19 wherein said active bromine content is above 160,000 ppm.

22. A method as in claim 19 wherein said active bromine content is in the range of about 176,000 ppm to about 190,000 ppm.

23. A method as in claim 19 wherein said active bromine content is in the range of about 201,000 ppm to about 215,000 ppm.

24. A method as in claim 13 wherein the biocide present in said water is an aqueous concentrate that has a pH of at least about 12.

25. A method as in claim 19 wherein said aqueous concentrate has a pH of at least about 12.

26. A method as in claim 19 further comprising discharging said water to the environment, and further comprising quenching said biocide.

27. A method as in claim 26 wherein said quenching is carried out by feeding a quenching agent to the water during said discharging.

28. A method as in claim 13 wherein the biocide present in said water is a solid state sulfamate-containing bromine-based biocidal composition formed by removal of water from an aqueous solution or slurry of a sulfamate-containing bromine-based biocide.

29. A method as in claim 28 wherein the aqueous solution or slurry from which water is removed is a product formed in water from (I) a bromine source which is (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine in proportions such that the total bromine to chlorine molar ratio is at least about 1; and (II) a source of overbased sulfamate which is (a) an alkali metal salt of sulfamic acid and/or sulfamic acid, and (b) an alkali metal base, wherein said aqueous solution or slurry has a pH of at least 7, and an atom ratio of nitrogen to active bromine from (I) and (II) of greater than 0.93.

30. A method as in claim 29 wherein the pH of said aqueous solution or slurry before removal of the water therefrom is above 7, and wherein the atom ratio of nitrogen to active bromine from (I) and (II) of said aqueous solution or slurry before removal of the water therefrom is greater than 1.

31. A composition for use in hydrostatic testing, said composition being comprised of water blended with a biocidally-effective amount of a sulfamate-containing bromine-based biocide, wherein at least a portion of said composition is used for hydrostatic testing of at least a portion of an oil or gas pipeline, which biocide has an active bromine content above 160,000 ppm.

32. A composition as in claim 31 wherein the biocide blended with said water is an aqueous concentrate formed from (A) a bromine source which is (i) bromine, (ii) bromine chloride, (iii) a mixture of bromine chloride and bromine, (iv) bromine and chlorine in a bromine to chlorine molar ratio of at least about 1, (v) bromine chloride, bromine, and chlorine in proportions such that the total bromine to chlorine molar ratio is at least about 1, (B) a source of sulfamate anions, (C) alkali metal base, and (D) water, in amounts such that the biocide has a pH of at least 7, and an atom ratio of nitrogen to active bromine from (A) and (B) that is greater than about 0.93.

33-34. (canceled)

35. A composition as in claim 32 wherein said active bromine content is in the range of about 176,000 ppm to about 190,000 ppm.

36. A composition as in claim 32 wherein said active bromine content is in the range of about 201,000 ppm to about 215,000 ppm.

37. A composition as in claim 31 wherein the biocide blended with said water is an aqueous concentrate that has a pH of at least about 12.

38. A composition as in claim 32 wherein said aqueous concentrate has a pH of at least about 12.

39. A composition for use in hydrostatic testing, said composition being comprised of water blended with a biocidally-effective amount of a sulfamate-containing bromine-based biocide, wherein at least a portion of said composition is used for hydrostatic testing of at least a portion of an oil or gas pipeline, wherein the biocide blended with said water is a solid state sulfamate-containing bromine-based biocidal composition formed by removal of water from an aqueous solution or slurry of a sulfamate-containing bromine-based biocide.

40. A composition as in claim 39 wherein the aqueous solution or slurry from which water is removed is a product formed in water from (I) a bromine source which is (i) bromine, (ii) bromine chloride, (iii) a mixture of bromine chloride and bromine, (iv) bromine and chlorine in a bromine to chlorine molar ratio of at least about 1, or (v) bromine chloride, bromine, and chlorine in proportions such that the total bromine to chlorine molar ratio is at least about 1; and (II) a source of overbased sulfamate which is (a) an alkali metal salt of sulfamic acid and/or sulfamic acid, and (b) an alkali metal base, wherein said aqueous solution or slurry has a pH of at least 7, and an atom ratio of nitrogen to active bromine from (I) and (II) of greater than 0.93.

41. A composition as in claim 40 wherein the pH of said aqueous solution or slurry before removal of the water therefrom is above 7, and wherein the atom ratio of nitrogen to active bromine from (I) and (II) of said aqueous solution or slurry before removal of the water therefrom is greater than 1.

42. A composition as in claim 31 wherein said composition further comprises at least one of the following additives:
(a) a corrosion inhibitor; and
(b) a scale inhibitor.

43. A composition as in claim 42 wherein said composition further comprises a corrosion inhibitor, and wherein said corrosion inhibitor is a filming amine.

44. A composition as in claim 43 wherein said filming amine is N′,N′,N′-polyoxyethylene-(10)-N-tallow-1,3-diaminopropane, alkyldimethylbenzylammonium chloride, or a mixture of any two or more of these.

45. A composition as in claim 42 wherein said composition further comprises a scale inhibitor, and wherein said scale inhibitor is a phosphate or a phosphonate, or a mixture thereof.

46. A composition as in claim 45 wherein said phosphate or phosphonate is aminomethylene phosphonic acid, hydroxyethylidene diphosphonic acid, phosphonobutanetricarboxylic acid, and 2,2′,2″-nitrilotris(ethanol) phosphate, or a mixture of any two or more of these.

47. A composition as in claim 42 wherein said composition further comprises a corrosion inhibitor and a scale inhibitor; wherein said corrosion inhibitor is N′,N′,N′-polyoxyethylene-(10)-N-tallow-1,3-diaminopropane, alkyldimethylbenzylammonium chloride, or a mixture of any two or more of these; and wherein said scale inhibitor is aminomethylene phosphonic acid, hydroxyethylidene diphosphonic acid, phosphonobutanetricarboxylic acid, and 2,2′,2″-nitrilotris(ethanol) phosphate, or a mixture of any two or more of these.
